(19) United States
(12) Patent Application Publication
(10) Pub. No.: US 2019/0021058 A1
(43) Pub. Date: Jan. 17, 2019

(54) METHOD AND APPARATUS FOR POWER SAVING IN A WIRELESS COMMUNICATION SYSTEM

(71) Applicant: FG Innovation IP Company Limited, Tuen Mun (CN)

(72) Inventors: YU-HSIN CHENG, Hsinchu (TW); CHIE-MING CHOU, Hsinchu (TW)

(21) Appl. No.: 16/036,961

(22) Filed: Jul. 17, 2018

Related U.S. Application Data
(60) Provisional application No. 62/533,300, filed on Jul. 17, 2017.

(51) Int. Cl. H04W 52/02; H04W 72/04; H04W 74/08

(52) U.S. Cl. CPC H04W 52/0235; H04W 74/0833; H04W 72/0453; H04W 72/042

(57) ABSTRACT

A method for power saving of a UE is provided. The method includes the following action. An RRC release with suspend configuration is received by a UE from a base station. A measurement configuration is received by the UE from the base station. The UE is transitioned from an RRC connected state to an RRC inactive state in response to the RRC release with suspend configuration. Paging information is received by the UE from the base station in response to the measurement configuration.

### CROSS REFERENCE

This application claims the benefit and priority to of U.S. Provisional Application Ser. No. 62/533,300, filed on Jul. 17, 2017, and entitled “METHOD AND APPARATUS FOR POWER SAVING IN INACTIVE STATE”, which is incorporated herein by reference in its entirety.

### TECHNICAL FIELD

The present disclosure generally relates to a method and apparatus for power saving in a wireless communication system.

### BACKGROUND

The next generation (e.g., 5^{th} generation (5G)) new radio (NR) wireless communication systems includes a new Radio Resource Control (RRC) state called RRC inactive state for a user equipment (UE) to stay in “always connected” mode. The RRC states include an RRC connected state, an RRC idle state, and the RRC inactive state. The UE can only be in one RRC state at any given time. The UE may transition from the RRC connected state to the RRC idle state, or from the RRC idle state to the RRC connected state. The UE may also transition from the RRC connected state to the RRC inactive state, or from the RRC inactive state to the RRC connected state. The UE may also transition from the RRC inactive state to the RRC idle state. However, the UE may not directly transition from the RRC idle state to the RRC inactive state. Instead, the UE needs to transition from the RRC idle state to the RRC connected state before transitioning to the RRC inactive state. The RRC inactive state can significantly reduce signaling overhead in a number of scenarios such as initial connection establishment or transition to a state where a UE starts exchanging data with the network.

### SUMMARY

In one aspect of the present disclosure, a method for power saving of a UE is provided. The method includes the following action. An RRC release with suspend configuration is received by a UE from a base station. A measurement configuration is received by the UE from the base station. The UE is transitioned from an RRC connected state to an RRC inactive state in response to the RRC release with suspend configuration. Paging information is received by the UE from the base station in response to the measurement configuration.

In another aspect of the present disclosure, a UE is provided. The UE includes a processor configured to perform the following instructions. An RRC release with suspend configuration is received by a UE from a base station. A measurement configuration is received by the UE from the base station. The UE is transitioned from an RRC connected state to an RRC inactive state in response to the RRC release with suspend configuration. Paging information is received by the UE from the base station in response to the measurement configuration.

In yet another aspect of the present disclosure, a method for power saving of a wireless communication system is provided. The wireless communication system includes a base station. The method includes the following actions. An RRC release with suspend configuration is transmitted from the base station to the UE. The UE is transitioned from an RRC connected state to an RRC inactive state in response to the RRC release with suspend configuration. A measurement configuration is transmitted from the base station to the UE. Paging information is transmitted from the base station to the UE in response to the measurement configuration.

In yet another aspect of the present disclosure, a base station is provided. The base station includes a processor configured to perform the following instructions. An RRC release with suspend configuration is transmitted from the base station to the UE. The UE is transitioned from an RRC connected state to an RRC inactive state in response to the RRC release with suspend configuration. A measurement configuration is transmitted from the base station to the UE. Paging information is transmitted from the base station to the UE in response to the measurement configuration.

### BRIEF DESCRIPTION OF THE DRAWINGS

FIG. 1 is a schematic diagram of a UE in an RRC inactive state according to an exemplary implementation of the present disclosure.

FIG. 2 is a schematic diagram of a wireless communication system according to an exemplary implementation of the present disclosure.

FIG. 3 is a schematic diagram of a method for power saving for a UE according to an exemplary implementation of the present disclosure.

FIG. 4 is a schematic diagram of a method for power saving for a UE according to an exemplary implementation of the present disclosure.

FIG. 5 is a schematic diagram of a method for power saving for a UE according to an exemplary implementation of the present disclosure.

FIG. 6 is a flowchart of a method for determining whether to perform a beam alignment procedure in response to a measurement configuration according to an exemplary implementation of the present disclosure.

FIG. 7 is a flowchart of a method for determining whether to perform a beam alignment procedure in response to a measurement configuration according to an exemplary implementation of the present disclosure.

FIG. 8 is a flowchart of a method for determining whether to perform a beam alignment procedure in response to a measurement configuration according to an exemplary implementation of the present disclosure.

FIG. 9 is a schematic diagram of a method for power saving for a UE according to an exemplary implementation of the present disclosure.

FIG. 10 is a schematic diagram of a random access procedure according to an exemplary implementation of the present disclosure.

FIG. 11 is a schematic diagram of a method for power saving for the UE according to an exemplary implementation of the present disclosure.

FIG. 12 is a schematic diagram of a method for power saving for the UE according to an exemplary implementation of the present disclosure.

### DETAILED DESCRIPTION

The following description contains specific information pertaining to exemplary implementations in the present disclosure. The drawings in the present disclosure and their accompanying detailed description are directed to merely exemplary implementations. However, the present disclosure is not limited to merely these exemplary implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions.

Several definitions that apply throughout the present disclosure will now be presented. The term “coupled” is defined as connected, whether directly or indirectly through intervening components, and is not necessarily limited to physical connections. The connection can be such that the objects are permanently connected or releasably connected.

In the present disclosure, a base station may include, but is not limited to, a node B (NB) as in the Universal Mobile Telecommunication System (UMTS), as in the LTE-A, a radio network controller (RNC) as in the UMTS, a base station controller (BSC) as in the GSM (Global System for Mobile Communication)/GERAN (GSM EDGE Radio Access Network), a ng-eNB as in an Evolved Universal Terrestrial Radio Access (E-UTRA) base station in connection with the 5G Core Network (5GC), a next generation node B (gNB) as in the 5G Access Network (5G-AN), an RRH (Remote Radio Head), a TRP (transmission and reception point), a cell, and any other apparatus capable of controlling radio communication and managing radio resources within a cell. The base station may connect to serve one or more UE(s) through a radio interface to the network.

In the present disclosure, a UE may include, but is not limited to, a mobile station, a mobile terminal or device, and a user communication radio terminal. For example, a UE may be a portable radio equipment, which includes, but is not limited to, a mobile phone, a tablet, a wearable device, a sensor, a personal digital assistant (PDA) with wireless communication capability, and other wireless devices equipping with an LTE access module or an NR (New Radio) access module. In the present disclosure, the UE is configured to communicate with a radio access network via the base station.

The UE or the base station may include, but is not limited to, a transceiver, a processor, a memory, and a variety of computer-readable media. The transceiver having transmitter and receiver configured to transmit and/or receive data. The processor may process data and instructions. The processor may include an intelligent hardware device, e.g., a central processing unit (CPU), a microcontroller, an application-specific integrated circuit (ASIC). The memory may store computer-readable, computer-executable instructions (e.g., software codes) that are configured to cause processor 826 to perform various functions. The memory may include volatile and/or non-volatile memory. The memory may be removable, non-removable, or a combination thereof. Exemplary memory may include solid-state memory, hard drives, optical-disc drives, and etc. The computer storage media stores information such as computer-readable instructions, data structures, program modules or other data. Computer-readable media can be any available media that can be accessed and include both volatile and non-volatile media, removable and non-removable media. By way of example, and not limitation, the computer-readable media may comprise computer storage media and communication media. The computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices.

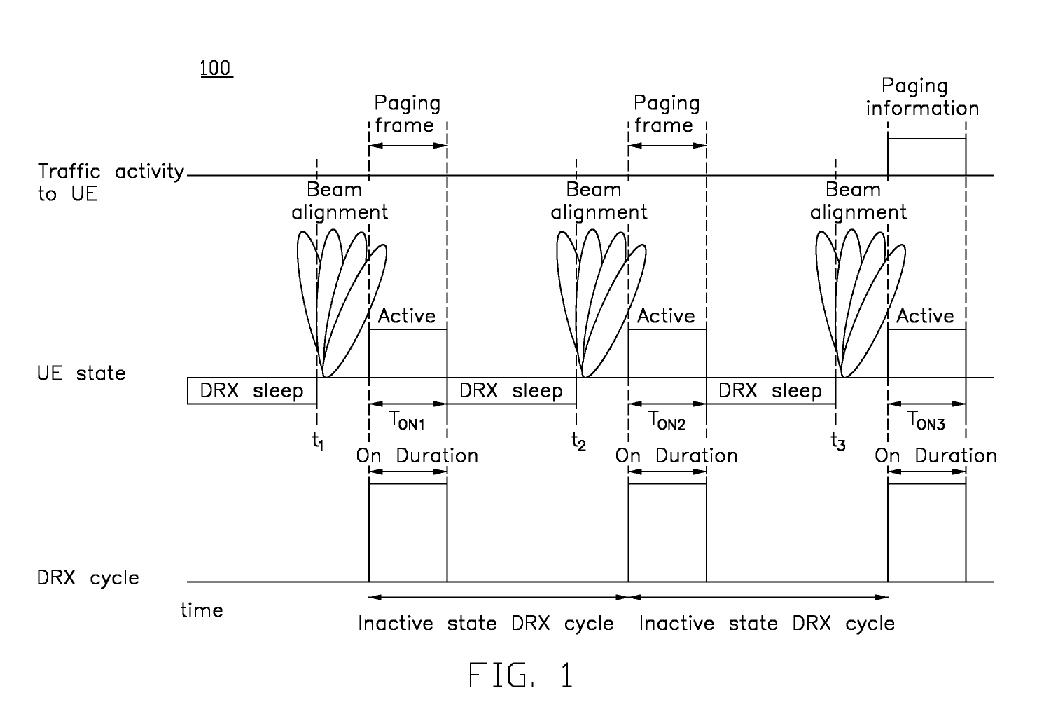

FIG. 1 is a schematic diagram of a UE in an RRC inactive state according to an exemplary implementation of the present disclosure. When a UE receives an RRC release with suspend message from a base station, the UE transitions from the RRC connected state to the RRC inactive state. The base station may inform the UE an RRC release with suspend configuration, which includes mobility control information (e.g., RAN-based paging area information). During the RRC inactive state, the UE monitors the RAN-based paging message based on mobility control information in order to transition to the RRC connected state if necessary. However, since 5G NR wireless networks adopt higher frequency bands than 4G wireless networks and the beam operations for coverage enhancement and data rate improvement are introduced, the UE has to perform beam alignment procedure before monitoring and receiving paging information (e.g., paging message and paging indication). During the beam alignment procedure, the UE attempts to find a qualified beam for receiving paging information. Similar to 4G LTE wireless networks, 5G NR wireless networks also support Discontinuous Reception (DRX) mechanism.

As shown in FIG. 1, an inactive state DRX cycle includes an On Duration period (e.g., T_{ON1}, T_{ON2}, T_{ON3}), which is configured by the base station. During the On Duration period, the UE monitors the downlink control channels (“Active”) to receive paging information in a paging frame from the base station. If paging information is received in the paging frame, the UE performs a random access procedure to transition to the RRC connected state. Before monitoring and receiving paging information, the UE has to perform beam alignment procedure (e.g., at time t₁, t₂, t₃). However, the beam alignment procedures performed before every On Duration period of the inactive state DRX cycle could cause lots of power consumption for inactive UE. Therefore, in this disclosure, several methods for power saving for the UE are provided as follows.

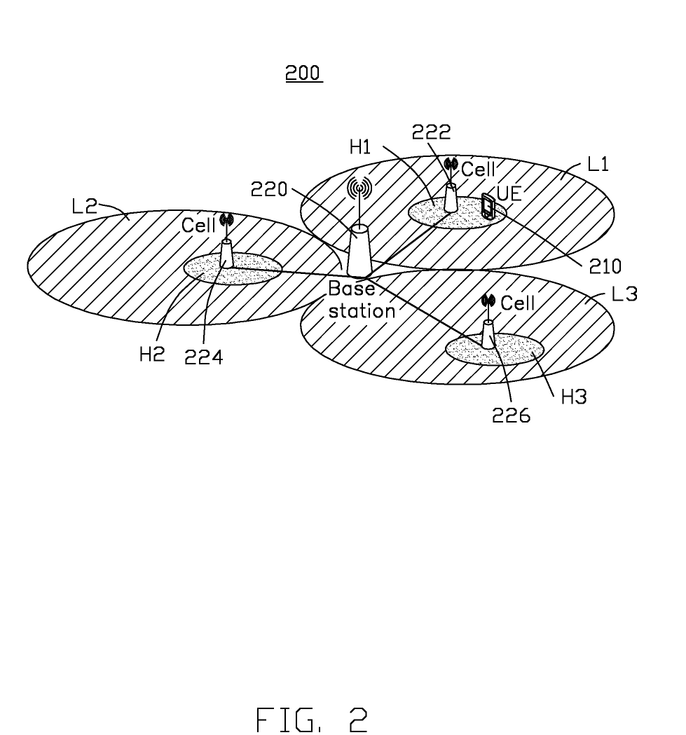

FIG. 2 is a schematic diagram of a wireless communication system 200 according to an exemplary implementation of the present disclosure. As shown in FIG. 2, the wireless communication system 200 may include at least one base station (e.g., 220) and at least one UE (e.g., 210). In this implementation, the at least one base station (e.g., 220) is configured to communicate with the at least one UE (e.g., 210) through a radio access network. The at least one base station (e.g., 220) may include one or more cells (e.g., 222, 224, 226). Each cell (e.g., 222, 224, 226) may support one or more frequency bands for a UE. For example, cell 222 supports a higher frequency band with smaller coverage (H1) and a lower frequency band with larger coverage (L1). Cell 224 supports a higher frequency band with smaller coverage (H2) and a lower frequency band with larger coverage (L2). Cell 226 supports a higher frequency band with smaller coverage (H3) and a lower frequency band with larger coverage (L3). When the UE 210 communicates with a cell for transmission and reception at a higher frequency band, the beam alignment procedure is required, while the UE 210 may communicate with a cell for transmission and reception at a lower frequency band without beam alignment procedures or with less beam alignment procedures. In this disclosure, several power saving mechanisms are described by assigning the UE 210 to monitor cells operating at a lower frequency band to reduce the number of beam alignment procedures to be performed by the UE in the RRC inactive state.

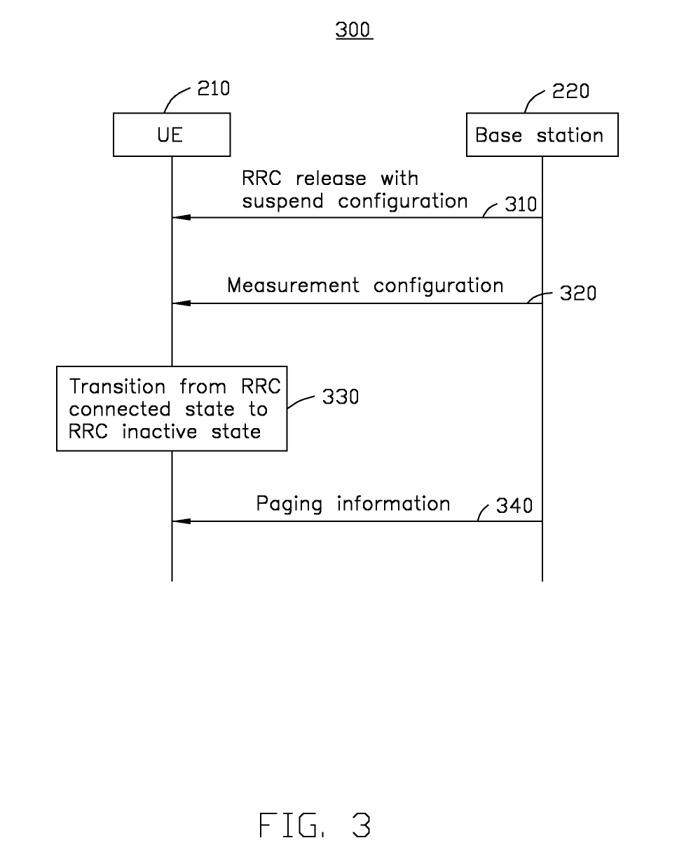

FIG. 3 is a schematic diagram of a method 300 for power saving for the UE according to an exemplary implementation of the present disclosure. In this exemplary implementation, a wireless communication system includes a UE 210 and a base station 220. In action 310, the UE 210 receives an RRC release with suspend configuration from the base station 220. In action 320, the UE 210 receives a measurement configuration from the base station 220. In action 330, after an RRC release with suspend message (not shown) is received from the base station 220, the UE 210 transitions from the RRC connected state to the RRC inactive state in response to the RRC release with suspend configuration. In action 340, the UE 210 receives paging information from the base station 220 in response to the measurement configuration.

In one implementation, the measurement configuration indicates the measurement objects for a UE (e.g., UE 210), and one measurement configuration may contains only one measurement object. The UE in the RRC inactive state may monitor paging channels based on the measurement object. For example, although the UE establishes an RRC connection with a cell in 3500 MHz frequency band, if the measurement configuration indicates 1800 MHz frequency band, the UE will only monitor and receive signals in the 1800 MHz frequency band instead of the 3500 MHz frequency band. It is noted that although the UE was paged upon a low frequency band, the UE may resume the RRC connection upon a high frequency band or other frequency bands.

In one implementation, the measurement configuration includes a frequency band. In another implementation, the measurement configuration includes a white cell list. In yet another implementation, the measurement configuration includes a black cell list. In yet another implementation, the measurement configuration includes a frequency band identifier. In yet another implementation, the measurement configuration includes a frequency list.

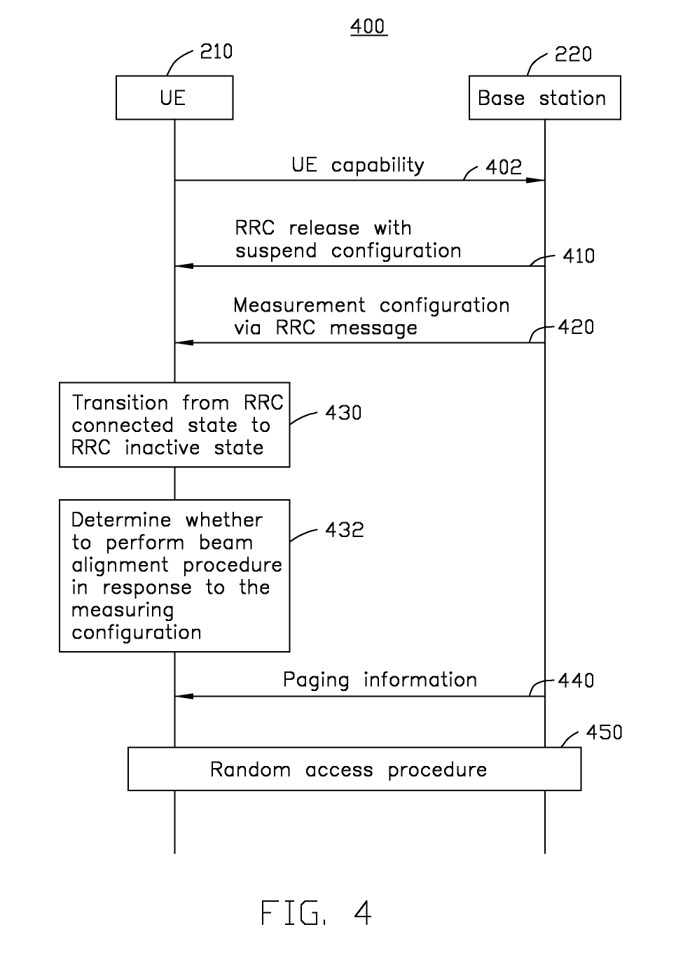

FIG. 4 is a schematic diagram of a method 400 for power saving for the UE according to an exemplary implementation of the present disclosure. In this exemplary implementation, a wireless communication system includes a UE 210 and a base station 220. In action 402, the UE 210 transmits a UE capability message to the base station 220. For example, the UE capability indicates the frequency band supported by the UE. In action 410, the UE 210 receives an RRC release with suspend configuration from the base station 220.

In action 420, the UE 210 receives a measurement configuration via an RRC message from the base station 220. In this implementation, the measurement configuration is generated in response to the UE capability. For example, the base station 220 configure the specific frequency band for the paging procedure or the RRC activation procedure (e.g., from RRC inactive state to RRC connected state). In action 430, after an RRC release with suspend message (not shown) is received from the base station 220, the UE 210 transitions from the RRC connected state to the RRC inactive state in response to the RRC release with suspend configuration. In action 432, the UE 210 determines whether to perform a beam alignment procedure in response to the measurement configuration.

In action 440, the UE 210 receives paging information from the base station 220 in response to the measurement configuration. When the paging information is received in the paging frame, in action 450, the UE 210 performs a random access procedure with the base station 220. In one implementation, the random access procedure is a contention free random access (CFRA) procedure. In another implementation, the random access procedure is a contention based random access (CBRA) procedure.

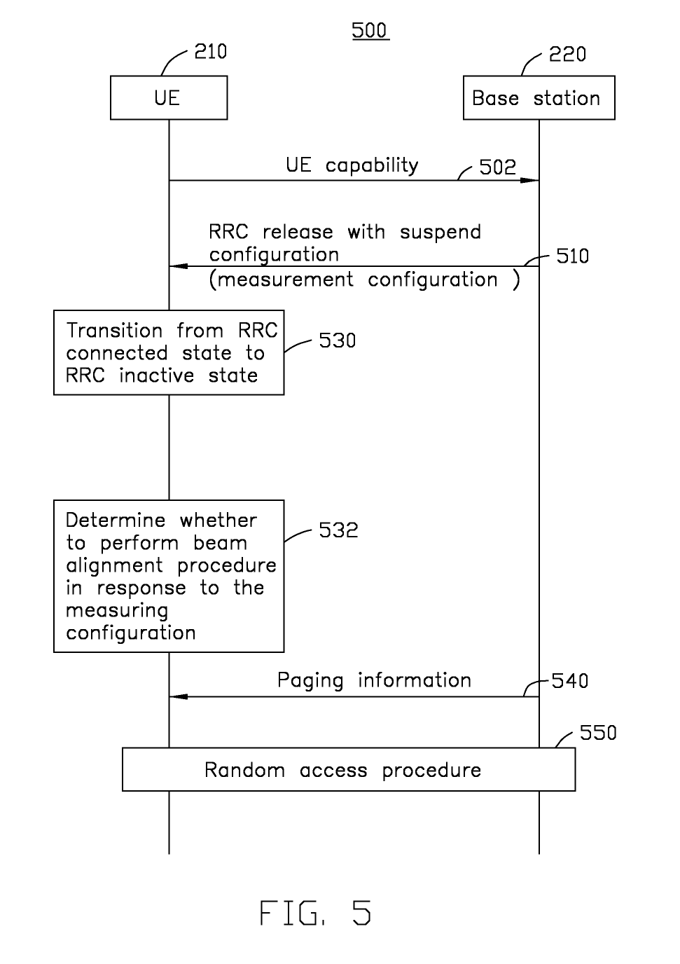

FIG. 5 is a schematic diagram of a method 500 for power saving for the UE according to an exemplary implementation of the present disclosure. In this exemplary implementation, the wireless communication system includes a UE 210 and a base station 220. In action 502, the UE 210 transmits a UE capability message to the base station 220. In action 510, the UE 210 receives an RRC release with suspend configuration from the base station 220. In this implementation, the measurement configuration is transmitted within the RRC release with suspend configuration. The measurement configuration is generated in response to the UE capability.

In action 530, after an RRC release with suspend message (not shown) is received from the base station 220, the UE 210 transition from the RRC connected state to the RRC inactive state in response to the RRC release with suspend configuration. In action 532, the UE 210 determine whether to perform a beam alignment procedure in response to the measurement configuration.

In action 540, the UE 210 receives paging information from the base station 220 in response to the measurement configuration. When the paging information is received in the paging frame, in action 550, the UE 210 performs a random access procedure with the base station 220. In one implementation, the random access procedure is a contention free random access (CFRA) procedure. In another implementation, the random access procedure is a contention based random access (CBRA) procedure.

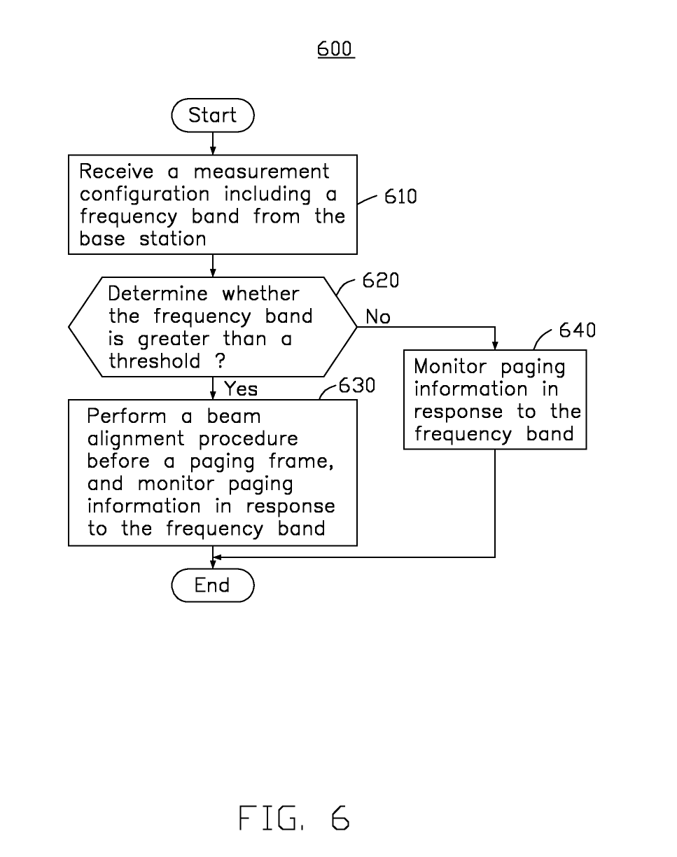

FIG. 6 is a flowchart of a method 600 for determining whether to perform a beam alignment procedure in response to a measurement configuration according to an exemplary implementation of the present disclosure. As shown in FIG. 6, in action 610, a UE (e.g., UE 210) receives a measurement configuration from a base station (e.g., base station 220). In this implementation, the measurement configuration includes a frequency information (e.g., frequency band). The UE determines whether to perform a beam alignment procedure before a paging frame in response to the frequency information. The frequency information may include, but not limited to, a frequency band, a frequency band identifier, a frequency index, an absolute frequency, and a frequency list. For example, the frequency band may be represented by a carrier frequency information element.

In action 620, the UE determines whether the frequency band is greater than a threshold. When the frequency band is greater than the threshold, in action 630, the UE performs a beam alignment procedure before a paging frame, and then monitors whether paging information is received in the paging frame in response to the frequency band. On the other hand, when the frequency band is not greater than the threshold, in action 640, the UE monitors whether paging information is received in a paging frame in response to the frequency band.

In one implementation, after the paging information is received, the UE performs a random access procedure with a cell in response to the frequency band within the measurement configuration. In another implementation, after the paging information is received, the UE performs a random access procedure with a cell in response to frequency information (e.g., a frequency band identifier) within the paging information. In one implementation, the UE selects a cell for performing the random access procedure in response to the frequency information. In another implementation, the UE determines a frequency band for performing the random access procedure in response to the cell index and the frequency information.

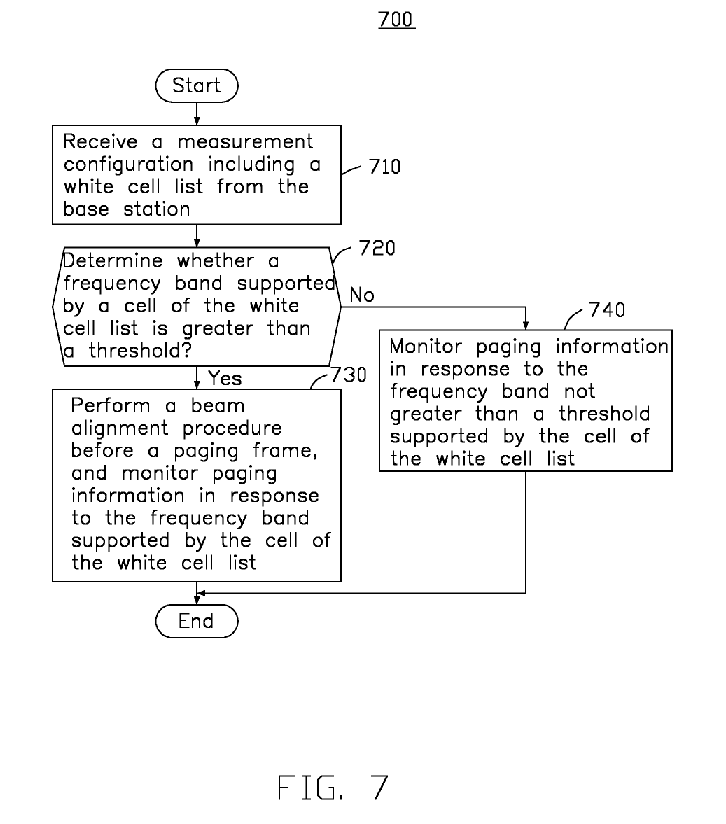

FIG. 7 is a flowchart of a method 700 for determining whether to perform a beam alignment procedure in response to a measurement configuration according to an exemplary implementation of the present disclosure. As shown in FIG. 7, in action 710, a UE (e.g., UE 210) receives a measurement configuration from a base station (e.g., base station 220). In this implementation, the measurement configuration includes a white cell list. For example, the white cell list may be represented by a white cell information element. The white cell list defines certain cells that the UE may select.

In action 720, the UE determines whether a frequency band supported by the selected cell of the white cell list is greater than a threshold. When the frequency band supported by the selected cell of the white cell list is greater than the threshold, in action 730, the UE performs a beam alignment procedure before a paging frame, and then monitors whether paging information is received in the paging frame in response to the frequency band supported by the selected cell of the white cell list. On the other hand, when the frequency band supported by the selected cell of the white cell list is not greater than the threshold, in action 740, the UE monitors whether paging information is received in a paging frame in response to the frequency band supported by the selected cell of the white cell list.

In another implementation, the UE determines whether the frequency band supported by all cells of the white cell list is greater than a threshold, and performs the beam alignment procedure when the frequency bands supported by all cells of the white cell list is greater than the threshold. Alternatively, when one of the frequency band supported by one of the cells of the white cell list is not greater than the threshold, the UE does not perform the beam alignment procedure, and monitors whether paging information is received in a paging frame in response to the frequency band not greater than the threshold supported by the cell of the white cell list.

In some implementations, after the paging information is received, the UE performs a random access procedure with a cell in response to the white cell list within the measurement configuration. In another implementation, after the paging information is received, the UE performs a random access procedure with a cell in response to frequency information (e.g., a frequency band identifier) within the paging information. In one implementation, the UE selects a cell for performing the random access procedure in response to the frequency information. In another implementation, the UE determines a frequency band for performing the random access procedure in response to the cell index and the frequency information.

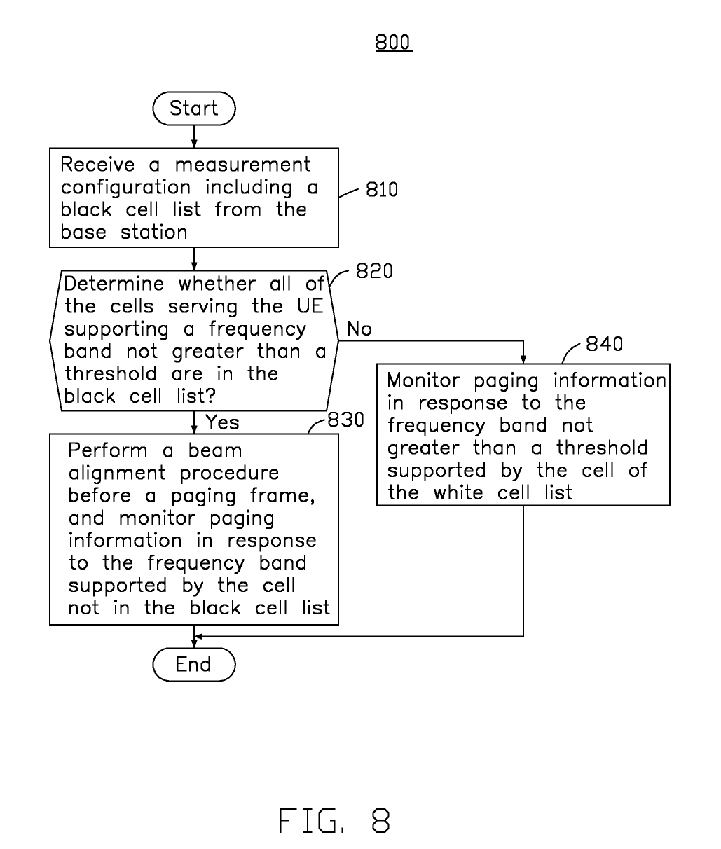

FIG. 8 is a flowchart of a method 800 for determining whether to perform a beam alignment procedure in response to a measurement configuration according to an exemplary implementation of the present disclosure. As shown in FIG. 8, in action 810, a UE (e.g., UE 210) receives a measurement configuration from a base station (e.g., base station 220). In this implementation, the measurement configuration includes a black cell list. The black cell list includes certain cells that the UE should avoid for the paging procedure. For example, the black cell list may be represented by a black cell information element. When a lower frequency band of the radio access network is overload, the black cell information element includes all cells supporting the lower frequency band only.

In action 820, the UE determines whether all of the serving cells supporting a frequency band not greater than a threshold are in the black list. When all of the serving cells supporting a frequency band not greater than a threshold are in the black list, in action 830, the UE performs a beam alignment procedure before a paging frame, and then monitors whether paging information is received in the paging frame in response to the frequency band supported by the cell not in the black cell list. On the other hand, when one of the serving cells supporting a frequency band not greater than the threshold is not in the black list, in action 840, the UE monitors whether paging information is received in a paging frame in response to the frequency band not greater than the threshold supported by the cell not in the black cell list.

In some implementations, after the paging information is received, the UE performs a random access procedure with a cell in response to the black cell list within the measurement configuration. In another implementation, after the paging information is received, the UE performs a random access procedure with a cell in response to frequency information (e.g., a frequency band identifier) within the paging information. In one implementation, the UE selects a cell for performing the random access procedure in response to the frequency information. In another implementation, the UE determines a frequency band for performing the random access procedure in response to the cell index and the frequency information.

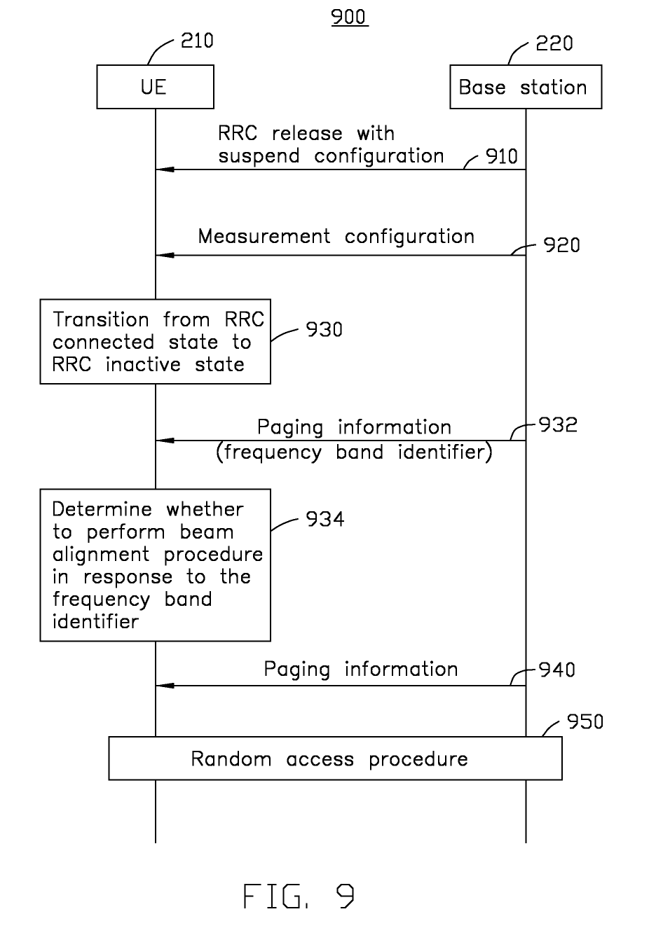

FIG. 9 is a schematic diagram of a method 900 for power saving for the UE according to an exemplary implementation of the present disclosure. In this exemplary implementation, the wireless communication system includes a UE 210 and a base station 220. In action 910, the UE 210 receives an RRC release with suspend configuration from the base station 220. In action 920, the UE 210 receives a measurement configuration from the base station 220. In one implementation, the measurement configuration is generated in response to the UE capability. In another implementation, the measurement configuration includes a frequency band. In yet another implementation, the measurement configuration includes a white cell list. In yet another implementation, the measurement configuration includes a black cell list.

In action 930, after an RRC release with suspend message (not shown) is received from the base station 220, the UE 210 transitions from RRC connected state to RRC inactive state in response to the RRC release with suspend configuration. In action 932, the UE 210 receives paging information including frequency band information from the base station 220 in response to the measurement configuration. In this implementation, the frequency band information includes a frequency band identifier. In another implementation, the frequency band information includes a frequency list.

In action 934, the UE 210 determines whether to perform a beam alignment procedure in response to the frequency band identifier. After the frequency band identifier is received in action 932, the UE monitors whether paging information is received in a paging frame in response to the frequency band identifier provided in action 932. In action 940, the UE 210 receives paging information from the base station 220 in response to the frequency band identifier. When the paging information is received in the paging frame, in action 950, the UE 210 performs a random access procedure with the base station 220. In one implementation, the random access procedure is a contention free random access (CFRA) procedure. In another implementation, the random access procedure is a contention based random access (CBRA) procedure.

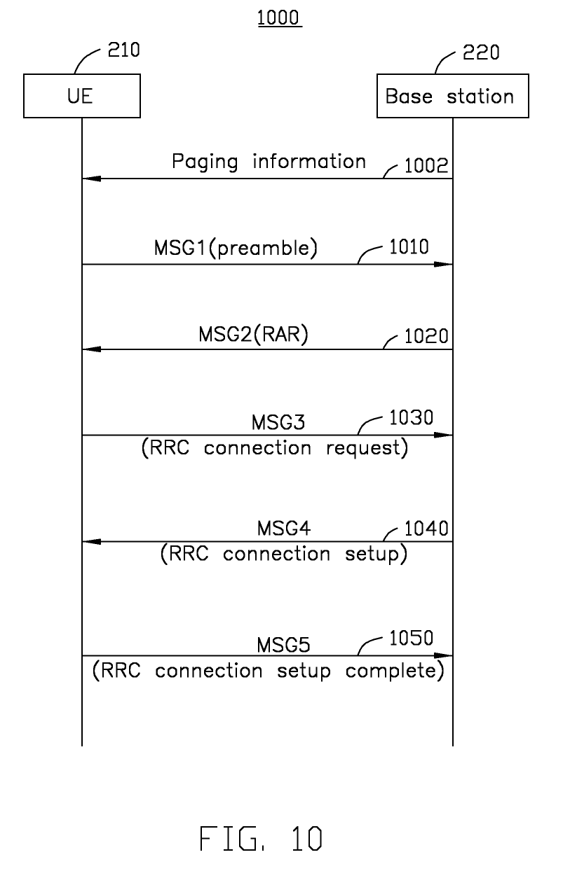

FIG. 10 is a schematic diagram 1000 of a random access procedure according to an exemplary implementation of the present disclosure. In this exemplary implementation, a wireless communication system includes a UE 210 and a base station 220. When the UE 210 in the RRC inactive state receives paging information (e.g., in action 1002) in a frequency band configured by the base station, the UE 210 will perform the random access procedure (e.g., an RRC Activation procedure from the RRC inactive state to the RRC connected state) in the configured frequency band accordingly. During the random access procedure, the UE 210 has to inform at least UE context ID, cause value (resume) and security information to the base station 220.

In this exemplary implementation, the UE 210 triggers a CBRA procedure. As shown in FIG. 10, in action 1010, the UE 210 transmits a MSG1 (e.g., random access preamble) to the base station 220. For example, the UE 210 sends MSG1 with one RACH resource and one PRACH resource in the frequency band configured by the base station 220. In action 1020, the UE 210 receives a MSG2 (e.g., random access response, RAR) in the RAR window from the base station 220. In MSG2, the base station 220 allocates resources for the UE 210 for transmitting a MSG3. If the UE 210 fails to receive the resource allocation information after performing the CBRA procedure several times, the UE 210 may transition to the RRC idle state and the base station 220 may release the RRC information of the UE 210.

In action 1030, the UE transmits the MSG3 (e.g., RRC connection request) to the base station 220. For example, the UE 210 transmits at least the UE context ID, cause value (resume) and security information to the base station 220 based on the scheduling information received in MSG2. In action 1040, the UE 210 receives a MSG4 (e.g., RRC connection setup) from the base station 220. In MSG4, the base station 220 assigns resources for the UE to transmit a MSG5 according to the UE 210's context ID and resume ID. In action 1050, the UE 210 transmits the MSG5 (e.g., RRC connection setup complete) to the base station 220 to complete the random access (e.g., RRC activation procedure).

In one implementation, the UE 210 may perform random access procedure in lower frequency band until the UE 210 successfully receives the MSG4. Since the UE 210 transmits the MSG3 including the UE ID to the base station 220, the base station 220 may configure the frequency band for the following transmission via the MSG4. After the UE 210 receives the RRC connection setup via the MSG4, the UE 210 may transmit the MSG5 (e.g., RRC connection setup complete) in response to the scheduling information (e.g., frequency band) in the MSG4. If the MSG5 (e.g., RRC connection setup complete) needs to be transmitted in a higher frequency band with a beam alignment procedure, the MSG4 (e.g., RRC connection setup) may contain CSI-RS resource configuration or SS block configuration for the UE 210 to perform the first step of uplink beam management procedure (U1) which is already defined in the 5G NR. On the other hand, if the MSG5 (e.g., RRC connection setup complete) needs to be transmitted in a lower frequency band without the beam alignment procedure, the UE 210 may transmit the MSG5 in response to the scheduling information contained in the MSG4.

In one implementation, the base station 220 decides whether to configure a higher or a lower frequency band based on the UE context ID, resume ID, etc. In another implementation, the base station 220 may dynamically assign the camping band for an RRC activation procedure based on an incoming data type. The dynamic indication may be appended with the paging message. For example, if the incoming data is only a burst packet, the base station 220 may assign a lower frequency band for the UE 210 to avoid inter-frequency band switching because the UE could go back to the RRC inactive state after receiving the burst packet. In yet another implementation, the base station 220 may assign a higher frequency band for the UE 210 if the incoming data is for video streaming which may sustain for a while and requires a higher throughput.

In one implementation, the dynamic indication may be transmitted via paging information. The dynamic indication may include a frequency band identifier (e.g. a frequency index, an absolute frequency, or a frequency list). In some implementation each UE ID recorded in the paging information is assigned with a frequency band identifier. If the frequency band identifier doesn't appear with the UE ID, the UE 210 may use the frequency band in which the base station 220 transmits the paging information. In some other implementations, the paging information indicates the frequency band identifier and the corresponding UE supporting the frequency band. The UE 210 performs the random access procedure in response to the frequency band identifier supported by the UE 210.

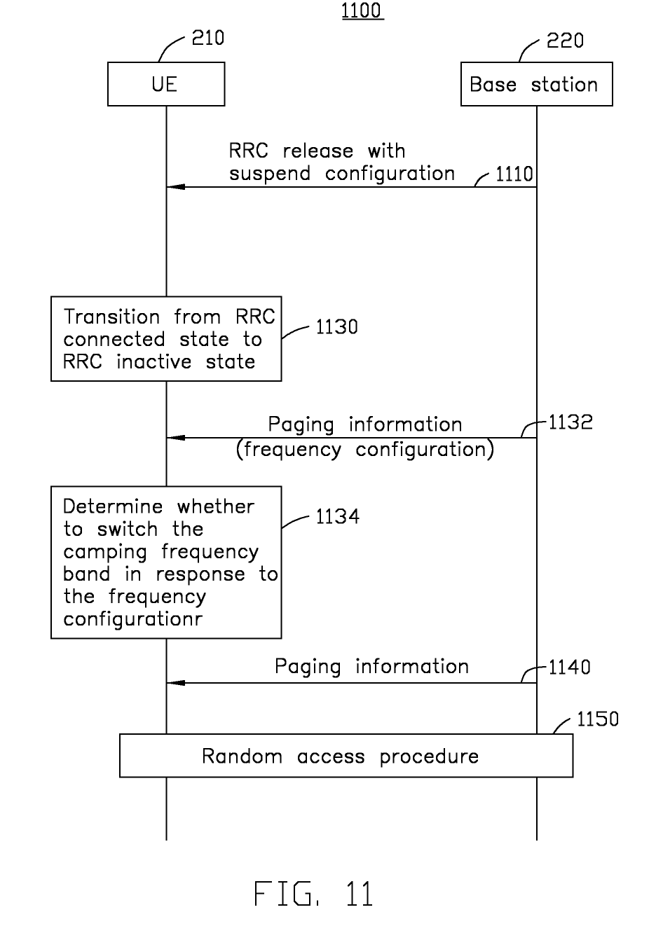

FIG. 11 is a schematic diagram of a method 1100 for power saving for the UE according to an exemplary implementation of the present disclosure. In this exemplary implementation, a wireless communication system includes a UE 210 and a base station 220. In action 1110, the UE 210 receives an RRC release with suspend configuration from the base station 220. In action 1130, after an RRC release with suspend message (not shown) is received from the base station 220, the UE 210 transitions from RRC connected state to RRC inactive state in response to the RRC release with suspend configuration. In action 1132, the UE 210 receives paging information including frequency configuration from the base station 220.

In one implementation, the frequency configuration may include, but not limited to, a frequency band, a frequency band identifier, a frequency index, an absolute frequency, and a frequency list. For example, the frequency band may be represented by a carrier frequency information element.

In action 1134, the UE 210 determines whether to switch the camping frequency band in response to the frequency configuration. When the camping frequency band is switched, the UE monitors whether paging information is received in a paging frame in response to frequency configuration provided in action 1132. When the UE 210 receives paging information in the paging frame from the base station 220 as shown in action 1140, in action 1150, the UE 210 performs a random access procedure with the base station 220. In one implementation, the random access procedure is a contention free random access (CFRA) procedure. In another implementation, the random access procedure is a contention based random access (CBRA) procedure.

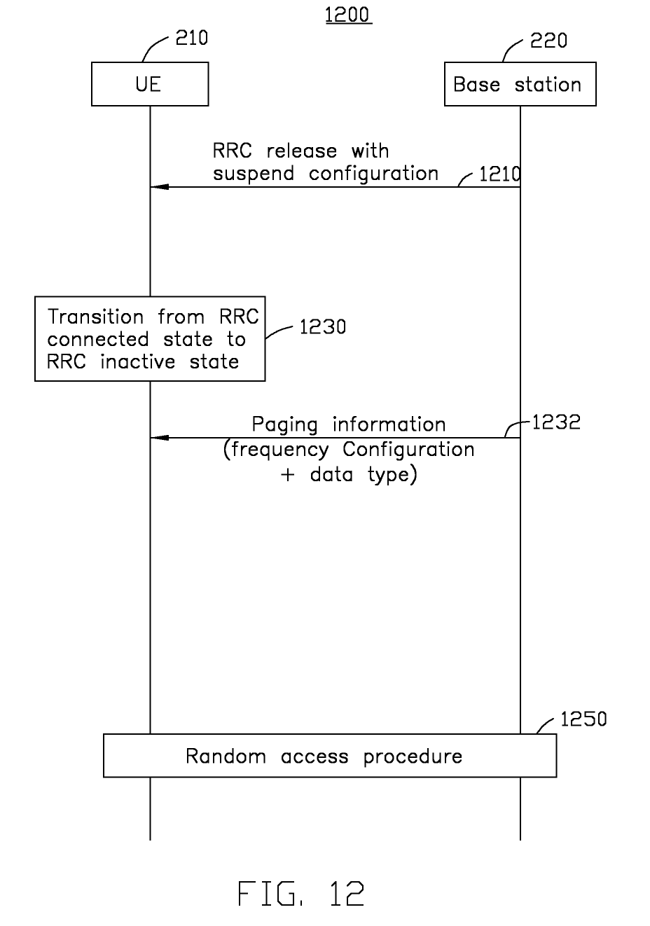

FIG. 12 is a schematic diagram of a method 1200 for power saving for the UE according to an exemplary implementation of the present disclosure. In this exemplary implementation, a wireless communication system includes a UE 210 and a base station 220. In action 1210, the UE 210 receives an RRC release with suspend configuration from the base station 220. In action 1230, after an RRC release with suspend message (not shown) is received from the base station 220, the UE 210 transitions from RRC connected state to RRC inactive state in response to the RRC release with suspend configuration.

In action 1232, the UE 210 receives paging information including frequency configuration from the base station 220. In this implementation, the paging information includes a data type, and the frequency configuration is associated with the data type. In one implementation, the data type is categorized by the data size. In another implementation, the data type is categorized by the type of the service. For example, if the data type is a burst packet, the base station 220 may assign a lower frequency band for UE to avoid inter-frequency band switching. In another example, the base station 220 may assign a higher frequency band for UE if the data type is a video streaming which may sustain for a while and require higher throughput.

In action 1250, the UE 210 performs a random access procedure with a cell of the base station 220 in response to the frequency configuration. In one implementation, the random access procedure is a contention free random access (CFRA) procedure. In another implementation, the random access procedure is a contention based random access (CBRA) procedure.

Based on the above, several methods for power saving for the UE and wireless communications are provided in this disclosure. The implementations shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for power saving of a user equipment (UE), the method comprising:
receiving, by the UE, a radio resource control (RRC) release with suspend configuration from a base station;
transitioning, by the UE, from an RRC connected state to an RRC inactive state in response to the RRC release with suspend configuration; and
receiving, by the UE, first paging information including a frequency configuration from the base station.

2. The method of claim 1, further comprising:
receiving, by the UE, second paging information from the base station in response to the frequency configuration.

3. The method of claim 1, further comprising:
performing, by the UE, a random access procedure with a cell in response to the frequency configuration.

4. The method of claim 1, wherein the frequency configuration includes at least one of:
a frequency index;
a frequency band;
a frequency band;
an absolute frequency; and
a frequency list;
determining, by the UE, whether to perform a beam alignment procedure before receiving the second paging information in response to the frequency configuration.

5. The method of claim 1, wherein the first paging information includes a data type, and the frequency configuration is associated with the data type.

6. A method for power saving of a wireless communication system, comprising:
transmitting, by a base station of the wireless communication system, a radio resource control (RRC) release with suspend configuration to a user equipment (UE), wherein the UE transitions from an RRC connected state to an RRC inactive state in response to the RRC release with suspend configuration;
transmitting, by the base station, first paging information including a frequency configuration to the UE.

7. The method of claim 6, further comprising:
transmitting, by the base station, second paging information to the UE in response to the frequency configuration.

8. The method of claim 6, further comprising:
receiving, by the base station, a random access preamble from the UE in response to the frequency configuration.

9. The method of claim 6, wherein the frequency configuration includes at least one of:
a frequency index;
a frequency band;
a frequency band;
an absolute frequency; and
a frequency list.

10. The method of claim 6, wherein the first paging information includes a data type, and the frequency configuration is associated with the data type.

11. A user equipment (UE), comprising:
a processor configured to perform instructions for:
receiving a radio resource control (RRC) release with suspend configuration from a base station;
transitioning from an RRC connected state to an RRC inactive state in response to the RRC release with suspend configuration; and
receiving paging information including a frequency configuration from the base station.

12. The UE of claim 11, wherein the processor is further configured to perform instructions for:
receiving second paging information from the base station in response to the frequency configuration.

13. The UE of claim 11, wherein the processor is further configured to perform instructions for:
performing a random access procedure with a cell in response to the frequency configuration.

14. The UE of claim 11, wherein the frequency configuration includes at least one of:
a frequency index;
a frequency band;
a frequency band;
an absolute frequency; and
a frequency list;
wherein the processor is further configured to perform instructions for:
determining whether to perform a beam alignment procedure before receiving the second paging information in response to the frequency configuration.

15. The UE of claim 11, wherein the first paging information includes a data type, and the frequency configuration is associated with the data type.

16. A base station, comprising:
a processor configured to perform instructions for:
transmitting a radio resource control (RRC) release with suspend configuration to a user equipment (UE), wherein the UE transitions from an RRC connected state to an RRC inactive state in response to the RRC release with suspend configuration;
transmitting first paging information including a frequency configuration to the UE.

17. The base station of claim 16, wherein the processor is further configured to perform instructions for:
transmitting second paging information to the UE in response to the frequency configuration.

18. The base station of claim 16, wherein the processor is further configured to perform instructions for:
receiving a random access preamble from the UE in response to the frequency configuration.

19. The base station of claim 16, wherein the frequency configuration includes at least one of:
a frequency index;
a frequency band;
a frequency band;
an absolute frequency; and
a frequency list.

20. The UE of claim 16, wherein the first paging information includes a data type, and the frequency configuration is associated with the data type.
